(19) United States
(12) Patent Application Publication
(10) Pub. No.: US 2004/0008158 A1
(43) Pub. Date: Jan. 15, 2004

(54) Head-mounted display

(76) Inventors: Axo Chi, Taipei (TW); Spencer Wu, Taipei (TW)

Correspondence Address: Harold V. Stotland, Seyfarth Shaw, 42nd Floor, 55 East Monroe Street, Chicago, IL, 60603-5803, US

(21) Appl. No.: 10/607,913

(22) Filed: Jun. 27, 2003

(30) Foreign Application Priority Data
Jul. 1, 2002 (TW) 091114574

(51) Int. Cl. G09G 5/00

(52) U.S. Cl. 345/8

(57) ABSTRACT

A head-mounted display comprises a wearing frame able to be mounted on head, a support frame, a video output terminal module and at least one display unit. Since the display unit can be combined with or detached from the video output terminal module, the head-mounted display can be changed into right-eye mode, left-eye mode, or twin-eyes mode. The video output terminal module is connected to the wearing frame through the support frame. The support frame is used to adjust the relative positions between the wearer and the display units along a vertical direction, a transverse direction, or a front-back direction.

### BACKGROUND OF THE INVENTION

1. Field of the invention

The present invention relates to a head-mounted display, and more particularly to a modularized head-mounted display, which satisfies detachability and adjustability requirements of a wearer so as to enhance comfort and convenience.

2. Description of the related art

In recent years, virtual reality, a kind of computer simulation technology, has been vigorously developed, and can make wearers temporarily feel that they exist in the three-dimensional (3D) space of a simulated real world. Through a head-mounted display, the imitative voices and images directly are sent to the sense organs of wearers. Due to previous practical experiences, they would really think of these imaginary imagines as real ones. Currently, such apparatus has widely applied in computer games. If a space positioner and a 3D joystick are added to the apparatus, there would be higher feeling of reality.

In addition to being standard apparatus of virtual reality, the head-mounted display may be used to further replace the display of a TV or a computer. Furthermore, it is also an optimal solution for privacy when one uses a notebook in public place to avoid peeping of the others. Also, many workers who constantly move about, for example, researchers, soldiers or stockjobbers, need to complete their works by wearing a head-mounted display.

Single-eye head-mounted display enables the wearer to browse the frames on its miniature screen with one eye, and handle other affairs with another eye. However, the conventional single-eye head-mounted display is suitable for one certain eye, and cannot be expanded to a two-eye mode. Even a single-eye head-mounted display designed for the right eye cannot be detached or changed for the left eye. As above described, the practical applications of the conventional head-mounted display are limited by their inflexible designs, thus a wearer has to buy various head-mounted displays according to different modes, which results in extra expenses.

FIG. 1 is a perspective diagram of the two-eye head-mounted display 10 disclosed in U.S. Pat. No. 6,115,007. The two-eye head-mounted display 10 comprises a main body 11 as a visual display modular and a wearing frame 12 as a head-mounted modular, wherein the main body 11 includes two display units for right and left eyes. Even though the wearing frame 12 can be easily on head, it is impossible to meet everybody's comfort requirements based on ergonomics for different dimensions of skulls and different interocular distances. Therefore, it is hard for every wearer to clearly and comfortably see the display of the convention head-mounted display.

### SUMMARY OF THE INVENTION

The first objective of the present invention is to provide a modularized head-mounted display whose display units are detachable and changeable among right-eye mode, left-eye mode and two-eye mode.

The second objective of the present invention is to provide an ergonomic head-mounted display whose wearing frame is flexible and adjustable according to various skull shapes and face figures of wearers so as to allow wearers to clearly and comfortably see the display of the head-mounted display.

The third objective of the present invention is to provide a simplified head-mounted display, which utilizes extension sockets for unifying the specifications of right-eye display unit and left-eye display unit.

In order to achieve the objectives, the present invention discloses a head-mounted display comprising a wearing frame capable of to being mounted on wearer's head, a support frame, a video output terminal module and at least one display unit. Since the display unit can be combined with or detached from the video output terminal module, the head-mounted display can be changed into right-eye mode, left-eye mode, and two-eye mode.

The video output terminal module is connected to the wearing frame through the support frame. The support frame is used to adjust the relative positions between the wearer and the display units along a vertical direction, a transverse direction, or a front-back direction.

### BRIEF DESCRIPTION OF THE DRAWINGS

The invention will be described according to the appended drawings in which:

FIG. 1 is a perspective diagram of the conventional twin-eyes head-mounted display disclosed in U.S. Pat. No. 6,115,007;

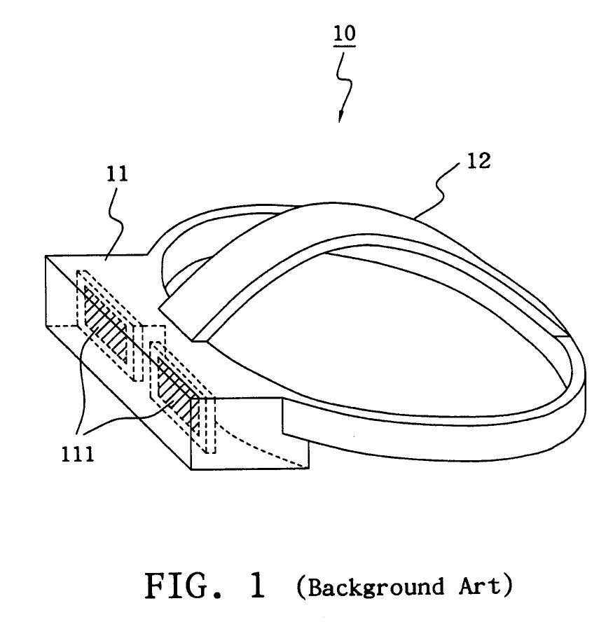

FIG. 2 is a perspective diagram of a two-eye head-mounted display of the present invention;

FIG. 3 is a perspective diagram of a single-eye head-mounted display of the present invention;

FIG. 4 is an exploded diagram of a video output terminal module and display units in accordance with the first embodiment of the present invention;

FIG. 5 is an exploded diagram of a video output terminal module and display units in accordance with the second embodiment of the present invention;

FIG. 6 is a side view of the head-mounted display of the present invention; and

FIG. 7 is a shows a perspective diagram of a single-eye head-mounted display in accordance with another embodiment of the present invention.

### PREFERRED EMBODIMENT OF THE PRESENT INVENTION

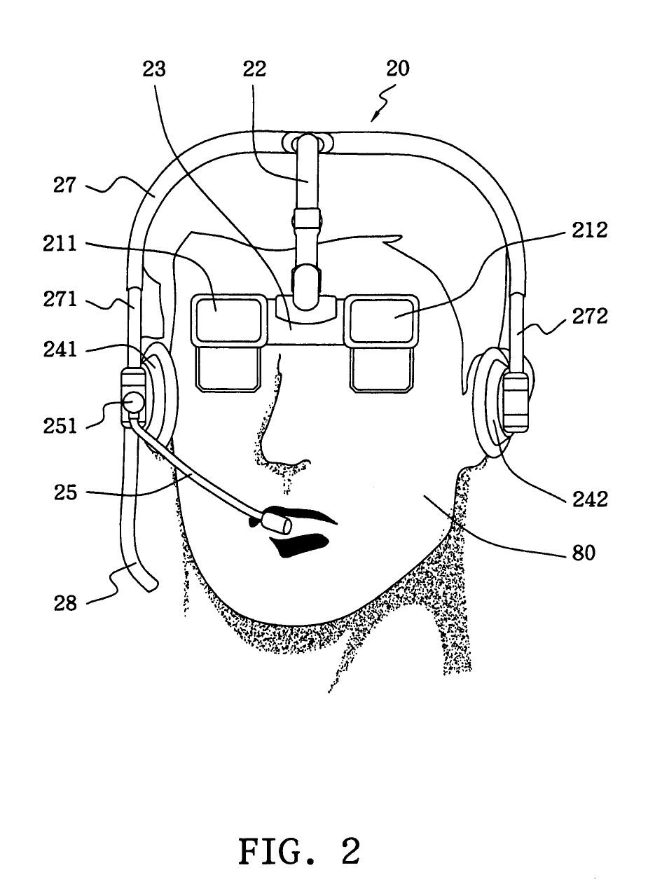

FIG. 2 is a perspective diagram of a two-eye head-mounted display of the present invention. The head-mounted display 20 is clasped on the head of a wearer 80 through a U-shaped main wearing frame 27, and two opposing sides of the main wearing frame 27 are provided with two secondary wearing frames 271 and 272 capable of flexibly adjusting downward and upward in such a manner of earphones. Furthermore, speakers 241 and 242 are separately fixed on the secondary wearing frames 271 and 272 around ears of the wearer 80 for applying music or voices. If the wearer 80 needs to communicate with other people, a microphone 25 electrically connected to an external microphone socket 251 is used for directly speaking to others. All external video and audio signals are transmitted to the secondary wearing frame 271 through a transmission line 28, and the transmission line 28 is divided into several signal lines (not shown), which are part embedded in the inside of the main wearing frame 27 and are separately connected to various signal output terminals, such as a video output terminal module 23 and the speakers 241 and 242.

As shown in FIG. 2, the wearer 80 sets the head-mounted display 20 at two-eye mode, that is, the left and right sides of the video output terminal module 23 separately have a first display unit 211 and a second display unit 212. The present invention is characterized in that the first display unit 211 and the second display unit 212 may switch their fixed positions with each other. Only one of them can be hung on the head-mounted display 20 for the wearer 80 to see a display screen on it with one eye. The video output terminal module 23 hanging on the forehead of the wearer 80 through a support frame 22 allows flexibly attaching and detaching the display units from it. The posture of the support frame 22 may be adjusted for viewing the display screen in several freedoms according to individual skull shapes and face figures; this will be described in detail afterward.

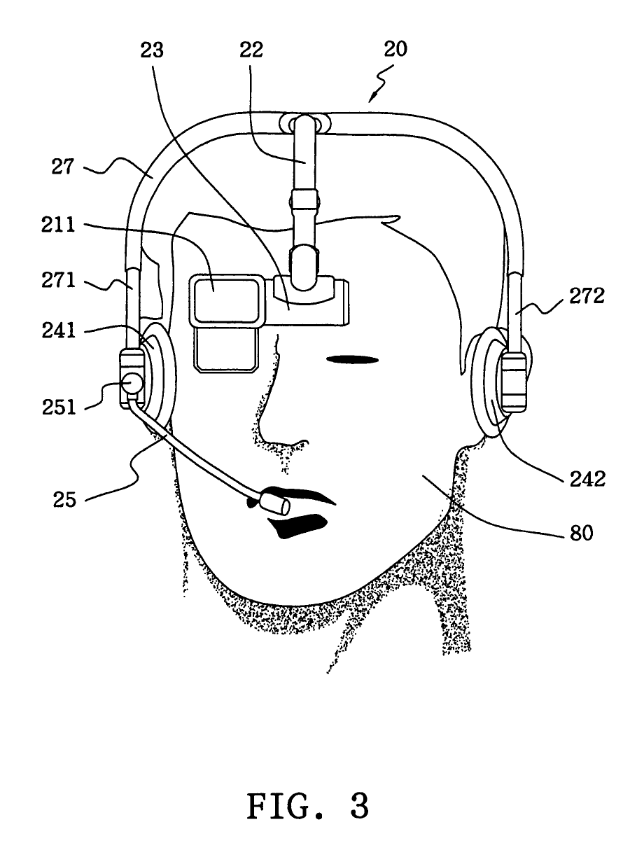

FIG. 3 is a perspective diagram of a single-eye head-mounted display of the present invention, wherein the head-mounted display 20 is set at right-eye mode especially for workers constantly moving about. Only the first display unit 211 is fixed on the position of the right eye. Furthermore, because wireless transmission technology is becoming more and more popular, Bluetooth technology can be applied to replace the transmission line 28 with wireless information transmission.

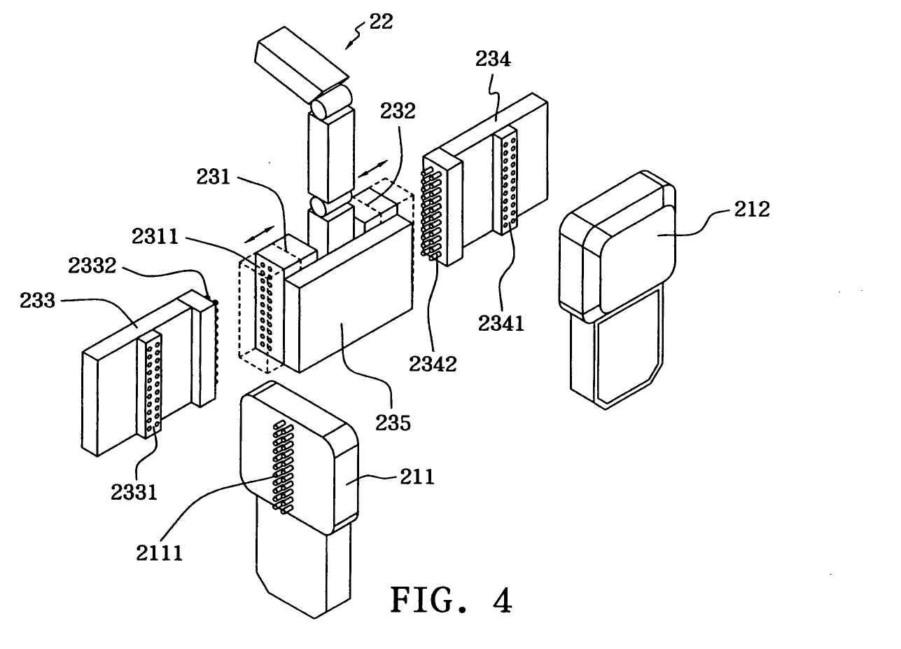

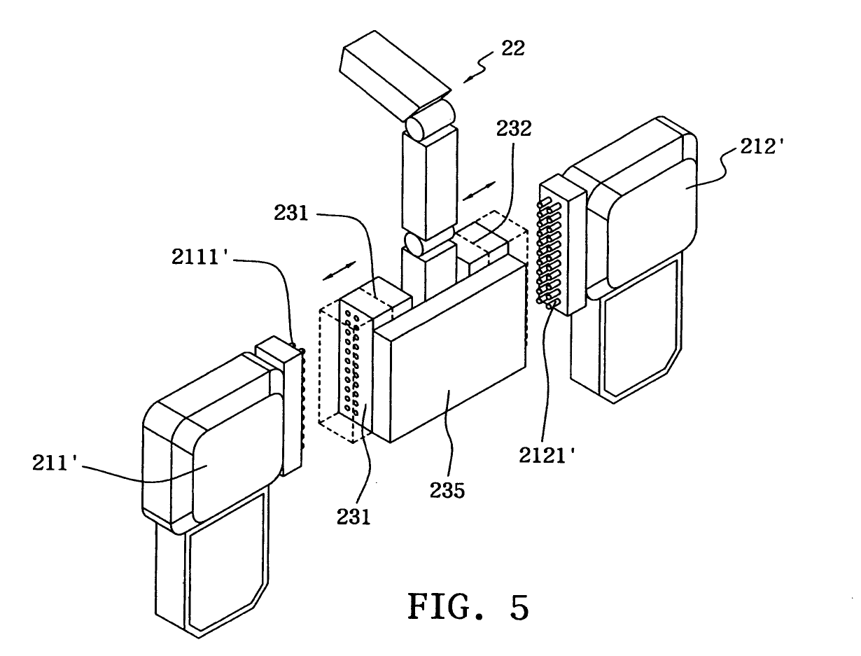

FIG. 4 is an exploded diagram of a video output terminal module and display units in accordance with the first embodiment of the present invention. The video output terminal module 23 shown in FIG. 2 comprises an output terminal base 235, a right output socket 231, a left output socket 232 and extension sockets 233 and 234. The positions of right output socket 231 and the left output socket 232 may be adjusted along arrow directions, and a sliding mechanism is set between them and the output terminal base 235, for example, a liner bearing or a dovetail groove and a dovetail. Such adjustable functions are specially designed for various interocular distances of wearers, and are helpful for the wearer 80 to clearly and comfortably see the display screen. A plug connecter 2311 provided on the right side of the right output socket 231 is used to connect with the plug 2332 of the extension socket 233. Furthermore, a socket 2331 provided on the middle of the extension socket 233 can connect with the plug 2111 of the first display 211. Because the first display 211 is symmetrical to the plug 2111, it can be switched from the right-eye position to the left-eye position. That is, the plug 2111 of the first display 211 can be plugged in the socket 2341 of the extension socket 234. In conclusion, the modularized video output terminal module 23 connecting with the unified display unit is easy to detach and assemble for setting its mode from two-eye mode, right-eye mode and left-eye mode as desired by the wearer. If the extension sockets 233 and 234 are taken from the above first embodiment, a first display unit 211′ with a plug 2111′ on its one side is directly plugged in the plug connecter 2311 of the right output socket 231, as shown in FIG. 5.

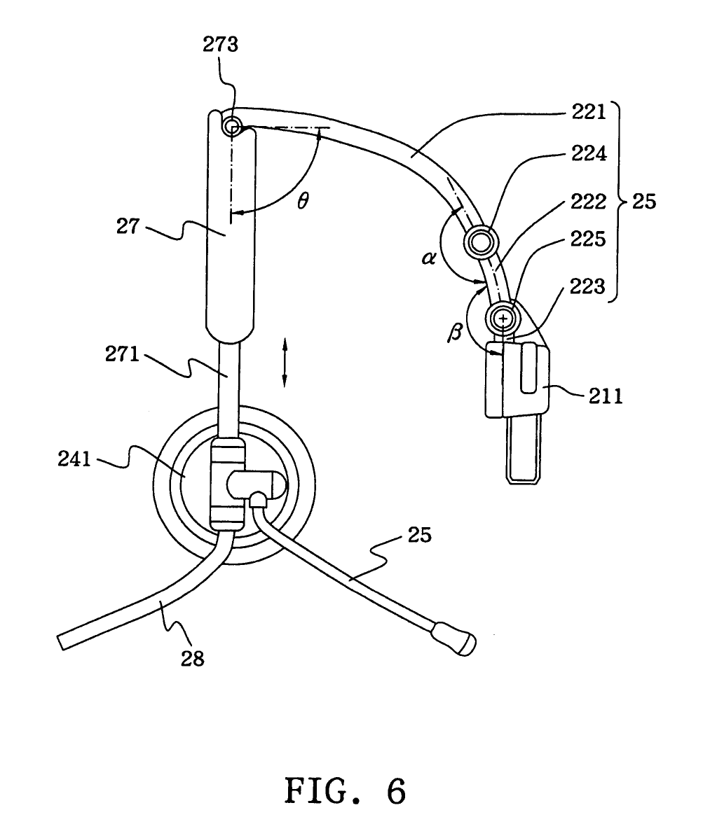

Another characteristic of the present invention is that the relative positions between the display unit and its corresponding eye can be easily changed. The support frame 22 utilizes multiple linkages, which comprise a first link 221, a second link 222, a third link 223, a rotatable joint 224, and a rotatable joint 225, to hang the first display unit 211 on the forehead of the wearer 80, as shown in FIG. 6. The first link 221 connects with the main wearing frame 27 through a rotatable joint 273, wherein an included angle θ between the first link 221 and the main wearing frame 27 is adjustable. Also, the second link 222 connects with the first link 221 through the rotatable joint 224, wherein an included angle α between the second link 222 and the first link 221 is adjustable. The third link 223 connects with the second link 222 through the rotatable joint 225, wherein an included angle β between the third link 223 and the second link 222 is also adjustable. The output terminal base 235 is fixed on the third link 223. By varying the three included angles θ, α, and β, a wearer can easily find his optimal viewing position, and does not have to bear uncomfortable view angle and distance any more.

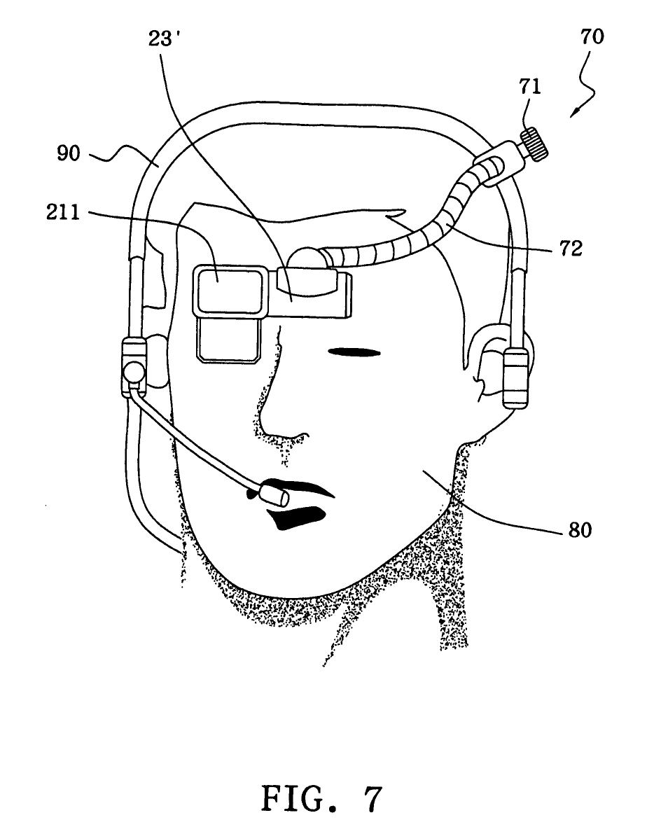

FIG. 7 is a shows a perspective diagram of a single-eye head-mounted display in accordance with another embodiment of the present invention. The support frame 72 is made of a flexible snake tube capable of being bent at will to have a greater adjustable range. In other words, the position of a video output terminal module 23′ can be switched in to all directions by turning the support frame 72. A general earphone set 90 can be combined with the support frame 72, and a clamping mechanism 71 can be utilized to fix the support frame 72 on one side or the middle of the earphone set 90. The clamping mechanism 71 made of a leaf spring or a spring lock can clamp on the frame of earphone set 90. Furthermore, a fastening band called a “hook-and-loop tape” or a screw fastening set is also taken as the clamping mechanism 71.

The above-described embodiments of the present invention are intended to be illustrative only. Numerous alternative embodiments may be devised by persons skilled in the art without departing from the scope of the following claims.

What is claimed is:

1. A head-mounted display, comprising:
a main wearing frame for placing on a wearer's head;
a support frame connected to the main wearing frame;
a video output terminal module fixed on the support frame support, the video output terminal module including a right output socket and a left output socket; and
at least one display unit connected to either the right output socket or the left output socket.

2. The head-mounted display of claim 1, wherein the video output terminal module includes an output terminal base for fixing the right output socket and the left output socket on the support frame.

3. The head-mounted display of claim 2, further comprising a plurality of sliding mechanisms for the output terminal base and the right and left output sockets to have relative sliding movements.

4. The head-mounted display of claim 1, wherein the video output terminal module further includes at least one extension socket connected to either the right output socket or the left output socket.

5. The head-mounted display of claim 1, wherein the support frame joins the main wearing frame by a rotatable joint.

6. The head-mounted display of claim 1, wherein the support frame includes at lease two links engaged by a rotatable joint.

7. The head-mounted display of claim 1, wherein the support frame is made of a flexible and shapeable snake tube.

8. The head-mounted display of claim 1, wherein the display unit is suitable for both eyes of the wearer.

9. The head-mounted display of claim 1, further comprising a speaker provided on the main wearing frame and near ears of the wearer.

10. The head-mounted display of claim 1, further comprising a microphone extended from the main wearing frame and near the wearer's mouth.

11. The head-mounted display of claim 1, wherein the main wearing frame includes two secondary wearing frames separately going forward both ears of the wearer.

12. The head-mounted display of claim 1, wherein the main wearing frame further includes a Bluetooth modular for receiving external video and audio signals.

13. A head-mounted display, comprising:
a clamping mechanism;
a support frame connected to the clamping mechanism;
a video output terminal module fixed on the support frame support, the video output terminal module including a right output socket and a left output socket; and
at least one display unit connected to either the right output socket or the left output socket.

14. The head-mounted display of claim 13, wherein the clamping mechanism is capable of clamping the main frame of an earphone set.

15. The head-mounted display of claim 13, wherein the support frame includes at least two links engaged by a rotatable joint.

16. The head-mounted display of claim 13, wherein the support frame is made of a flexible and shapeable snake tube.

17. The head-mounted display of claim 13, wherein the video output terminal module includes an output terminal base for fixing the right output socket and the left output socket on the support frame.

18. The head-mounted display of claim 17, further comprising a plurality of sliding mechanisms for the output terminal base and the right and left output sockets to have relatively sliding movements.

19. The head-mounted display of claim 13, wherein the video output terminal module further includes at least one extension socket connected to either the right output socket or the left output socket.

20. The head-mounted display of claim 13, wherein the main wearing frame further includes a Bluetooth modular for receiving external video and audio signals.
